(19) United States
(12) Patent Application Publication
(10) Pub. No.: US 2005/0114132 A1
(43) Pub. Date: May 26, 2005

(54) Voice interactive method and system

(75) Inventor: Tien-Ming Hsu, Taipei Hsien (TW)

Correspondence Address: NIXON & VANDERHYE, PC, 1100 N GLEBE ROAD, 8TH FLOOR, ARLINGTON, VA, 22201-4714, US

(73) Assignee: ACER INC., Taipei Hsien (TW)

(21) Appl. No.: 10/781,880

(22) Filed: Feb. 20, 2004

(30) Foreign Application Priority Data
Nov. 21, 2003 (TW) 092132768

(51) Int. Cl. G10L 15/04

(52) U.S. Cl. 704/251

(57) ABSTRACT

In a voice interactive system, a detecting module detects presence of a predetermined keyword in an input voice signal. When the presence of the predetermined keyword is detected, the detecting module switches operation of a semantic recognition module from a disabled mode to an enabled mode, where the semantic recognition module performs semantic recognition upon the input voice signal. A response module generates a response according to result of the semantic recognition. A timer module operates simultaneously with operation of the semantic recognition module in the enabled mode so as to calculate and determine whether an idle time between a current input voice signal and a previous input voice signal is larger than a predetermined threshold. In the affirmative, a mode switching module enables the detecting module to switch operation of the semantic recognition module back to the disabled mode.

### CROSS-REFERENCE TO RELATED APPLICATION

This application claims priority of Taiwanese application no. 092132768, filed on Nov. 21, 2003.

### BACKGROUND OF THE INVENTION

1. Field of the Invention

The invention relates to a method and system for voice interaction, more particularly to a voice interactive method and system that involves both keyword-activation and idle time-calculation techniques.

2. Description of the Related Art

At present, in consideration of convenience and user-friendliness, in addition to conventional manual and wireless controls, voice interactive control is also widely implemented as a control interface in electronic products, especially in view of its advantages of wireless control and artificial voice response. Voice interactive control systems involve well-known voice recognition techniques. For instance, in U.S. Pat. No. 5,692,097, there is disclosed a voice recognition method for recognizing a word in speech through calculation of similarity between an input voice and a standard patterned word. Moreover, in U.S. Pat. No. 5,129,000, there is disclosed a voice recognition method through analysis of syllables.

There are three modes currently used in man-machine voice interactive systems: (1) Free-to-Talk; (2) Push-to-Talk; and (3) Talk-to-Talk. In each of the Free-to-Talk and Push-to-Talk modes, voice recognition is performed upon an input voice signal, and a responsive command is subsequently retrieved from a database based on the recognition result. Thereafter, an electronic device that incorporates the voice interactive system executes the responsive command, such as on/off, volume adjustment, etc. The Free-to-Talk and Push-to-Talk modes differ primarily in that the latter requires a user-initiated action (such as pushing of a button) to activate the voice interactive system before a voice command can be issued to the electronic device. On the other hand, in the Free-to-Talk mode, since the electronic device is always in an active standby state, there is no need to perform a user-initiated action before issuing a voice command.

Voice interactive systems that are based on the Free-to-Talk and Push-to-Talk modes are disadvantageous in that they are inconvenient to use. In the Free-to-Talk mode, input voice signals are always considered by the voice interactive system as potential voice commands such that the voice interactive system is likely to misjudge and cause electronic devices to perform an unwanted response when applied to a noisy environment or when an unintended command is picked up from the user. In the Push-to-Talk mode, although possible unwanted responses are eliminated through the need for a user-initiated action before a voice command can be executed, it is inconvenient for the user to perform the user-initiated action each time a voice command is to be issued.

Like in the Free-to-Talk mode, the Talk-to-Talk mode requires the electronic device to be in an active standby state. However, like the Push-to-Talk mode, a confirmation procedure is required in the Talk-to-Talk mode when issuing a voice command. In the Talk-to-Talk mode, the confirmation procedure involves the presence of a keyword in the issued voice command so as to minimize occurrence of unwanted responses. However, voice interactive systems that are based on the Talk-to-Talk mode are disadvantageous in that, each time the user wants to issue a voice command, a keyword must be present therein for activating the voice interactive system. The following example is provided to illustrate a typical conversation in the Talk-to-Talk mode. In the example, it is assumed that the system keyword is “Jack”, and the electronic device that incorporates the voice interactive system is a multi-media playback apparatus:

User: Jack, activate the CD player.

System: All right, I'll activate the CD player for you.

User: Jack, play the songs of xxx.

System: All right, I'll play the songs of xxx for you.

User: Jack, play the third song.

System: All right, I'll play the third song for you.

User: Jack, turn the music up.

System: All right, I'll turn up the music for you.

As evident from the above conversation, the voice interactive system based on the Talk-to-Talk mode is inconvenient to use since the same keyword is repeated when the user issues voice commands. In addition, the user's dialogue with the voice interactive system is awkward and somewhat impolite.

### SUMMARY OF THE INVENTION

Therefore, the object of the present invention is to provide a method and system for voice interaction that can overcome the aforesaid drawbacks associated with the prior art.

According to one aspect of the present invention, there is provided a voice interactive method that comprises:
a) performing voice recognition upon an input voice signal to detect presence of a predetermined keyword;
b) upon detecting that the input voice signal contains the predetermined keyword, performing semantic recognition upon the input voice signal;
c) generating a response according to result of the semantic recognition performed in step b);
d) simultaneous with step b), calculating an idle time between a current input voice signal and a previous input voice signal; and
e) disabling the semantic recognition of the input voice signal, and repeating step a) when the idle time calculated in step d) is larger than a predetermined threshold.

According to another aspect of the present invention, there is provided a selective voice recognition method that comprises:
a) performing voice recognition upon an input voice signal to detect presence of a predetermined keyword;
b) upon detecting that the input voice signal contains the predetermined keyword, performing semantic recognition upon the input voice signal;
c) simultaneous with step b), calculating an idle time between a current input voice signal and a previous input voice signal; and
d) disabling the semantic recognition of the input voice signal, and repeating step a) when the idle time calculated in step c) is larger than a predetermined threshold.

According to yet another aspect of the present invention, there is provided a voice interactive system that comprises a detecting module, a semantic recognition module, a response module, a timer module, and a mode switching module. The detecting module is adapted for performing voice recognition upon an input voice signal to detect presence of a predetermined keyword. The semantic recognition module is coupled to and controlled by the detecting module so as to switch operation from a disabled mode to an enabled mode, where the semantic recognition module performs semantic recognition upon the input voice signal, when the presence of the predetermined keyword in the input voice signal is detected by the detecting module. The response module is coupled to and controlled by the semantic recognition module so as to generate a response according to result of the semantic recognition performed by the semantic recognition module. The timer module operates simultaneously with operation of the semantic recognition module in the enabled mode so as to calculate an idle time between a current input voice signal and a previous input voice signal, and so as to determine whether the idle time calculated thereby is larger than a predetermined threshold. The mode switching module is coupled to the timer module and the detecting module, and enables the detecting module to switch operation of the semantic recognition module from the enabled mode back to the disabled mode upon detection by the timer module that the idle time between the current input voice signal and the previous input voice signal is larger than the predetermined threshold.

According to a further aspect of the present invention, there is provided a selective voice recognition system that comprises a detecting module, a semantic recognition module, a timer module, and a mode switching module. The detecting module is adapted for performing voice recognition upon an input voice signal to detect presence of a predetermined keyword. The semantic recognition module is coupled to and controlled by the detecting module so as to switch operation from a disabled mode to an enabled mode, where the semantic recognition module performs semantic recognition upon the input voice signal, when the presence of the predetermined keyword in the input voice signal is detected by the detecting module. The timer module operates simultaneously with operation of the semantic recognition module in the enabled mode so as to calculate an idle time between a current input voice signal and a previous input voice signal, and so as to determine whether the idle time calculated thereby is larger than a predetermined threshold. The mode switching module is coupled to the timer module and the detecting module, and enables the detecting module to switch operation of the semantic recognition module from the enabled mode back to the disabled mode upon detection by the timer module that the idle time between the current input voice signal and the previous input voice signal is larger than the predetermined threshold.

According to yet a further aspect of the present invention, there is provided an electronic device that comprises a sound pickup module, a detecting module, a semantic recognition module, a response module, a timer module, and a mode switching module. The sound pickup module is adapted for receiving an input voice signal. The detecting module is coupled to a sound pickup module and is operable so as to perform voice recognition upon an input voice signal to detect presence of a predetermined keyword. The semantic recognition module is coupled to and controlled by the detecting module so as to switch operation from a disabled mode to an enabled mode, where the semantic recognition module performs semantic recognition upon the input voice signal, when the presence of the predetermined keyword in the input voice signal is detected by the detecting module. The response module is coupled to and controlled by the semantic recognition module so as to generate a response according to result of the semantic recognition performed by the semantic recognition module. The timer module operates simultaneously with operation of the semantic recognition module in the enabled mode so as to calculate an idle time between a current input voice signal and a previous input voice signal, and so as to determine whether the idle time calculated thereby is larger than a predetermined threshold. The mode switching module is coupled to the timer module and the detecting module, and enables the detecting module to switch operation of the semantic recognition module from the enabled mode back to the disabled mode upon detection by the timer module that the idle time between the current input voice signal and the previous input voice signal is larger than the predetermined threshold.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of an electronic device that incorporates the preferred embodiment of a voice interactive system according to the present invention;

FIG. 2 is a block diagram to illustrate components of the voice interactive system of the preferred embodiment;

FIG. 3 is a block diagram to illustrate a detecting module of the voice interactive system of the preferred embodiment; and

FIG. 4 is a flowchart to illustrate steps of the preferred embodiment of a voice interactive method according to the present invention.

### DETAILED DESCRIPTION OF THE PREFERRED EMBODIMENT

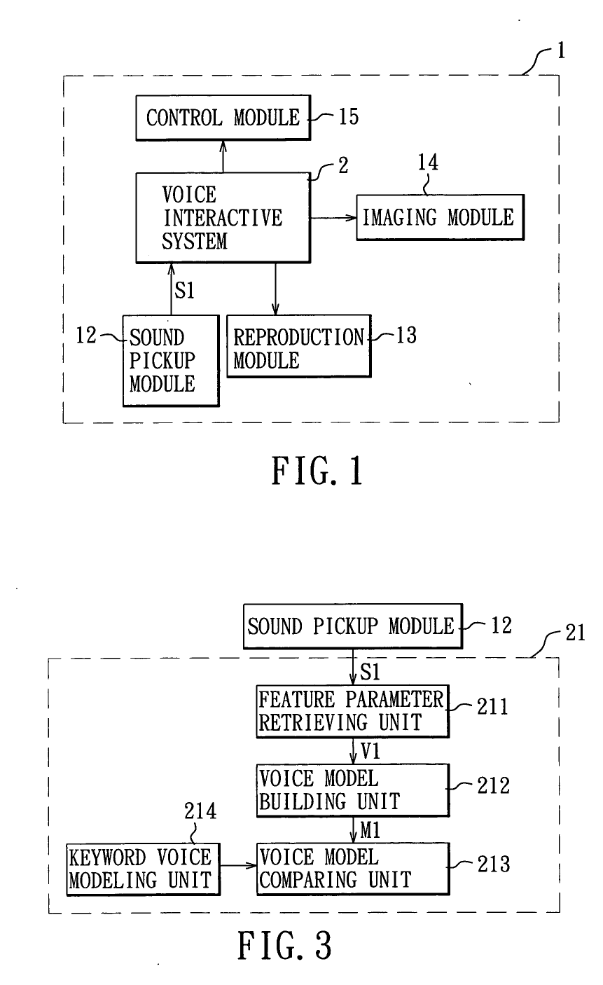

Referring to FIG. 1, an electronic device 1 that incorporates the preferred embodiment of a voice interactive system 2 according to the present invention is shown to include a control module 15, a sound pickup module 12, a reproduction module 13, and an imaging module 14. The control module 15 is preferably formed from one or more semiconductor chipsets. The sound pickup module 12 includes a sound pickup device for receiving an input voice signal from the user and for converting the input voice signal into an analog electrical signal, which is subsequently converted into a digital input voice signal at a predetermined sampling frequency with the use of an analog-to-digital converter (ADC). The reproduction module 13 is operable to convert artificial voice response data into an analog output through a digital-to-signal converter (DAC), the analog output being subsequently and audibly reproduced through a loudspeaker. The imaging module 14 includes a display device, such as a liquid crystal display (LCD), which is operable to display images and texts.

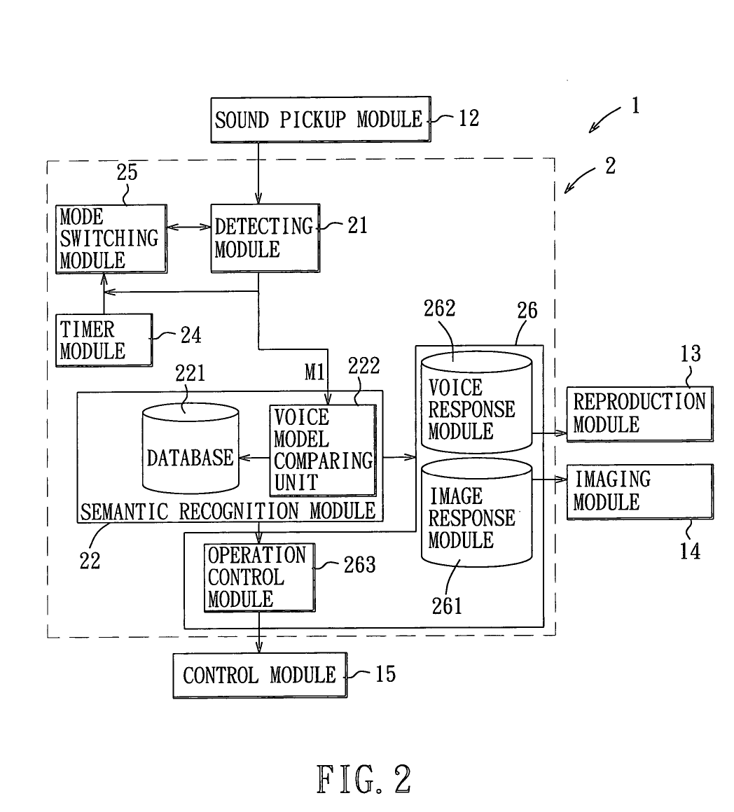

Referring to FIG. 2, the voice interactive system 2 includes a detecting module 21, a semantic recognition module 22, a timer module 24, a mode switching module 25, and a response module 26 including an image response module 261, a voice response module 262, and an operation control module 263. The function of each module of the voice interactive system 2 is provided by a respective program code which is stored in a recording medium (such as an optical disc, a hard disk, a memory, etc.) that is either built into or connected to the electronic device 1, or which is coded directly into a microprocessor or a semiconductor chip.

Referring to FIG. 3, the detecting-module 21 is coupled to the sound pickup module 12 and is operable so as to perform voice recognition upon the digital input voice signal from the sound pickup module 12 to detect the presence of a predetermined keyword. The detecting module 21 includes a feature parameter retrieving unit 211, a voice model building unit 212 coupled to the feature parameter retrieving unit 211, a voice model comparing unit 213 coupled to the voice model building unit 212, and a keyword voice modeling unit 214 coupled to the voice model comparing unit 213.

The feature parameter retrieving unit 211 receives the digital input voice signal (S1) from the sound pickup module 12, and retrieves feature parameters (V1) thereof in a known manner, such as through the steps of windowing, Linear Predictive Coefficient (LPC) processing, and Cepstral coefficient processing. The feature parameters (V1) are outputted to the voice model building unit 212 for building voice models (M1). In this embodiment, the Hidden Markov Model (HMM) technique is adopted for recognizing the feature parameters (V1) when building the voice models (M1). Since details of the Hidden Markov Model (HMM) technique can be found in various literatures, such as U.S. Pat. No. 6,285,785, a detailed description of the same is omitted herein for the sake of brevity. However, it is noted that the building of voice models may be implemented using neural networks. Therefore, implementation of the same should not be limited to the disclosed embodiment.

After the voice models (M1) are built, the voice models (M1) are outputted to the voice model comparing unit 213 for comparison with samples of keyword voice models stored in the keyword voice modeling unit 214. The voice model comparing unit 213 detects whether a similarity between the voice models (M1) and those from the keyword voice modeling unit 214 has reached a predetermined threshold. Therefore, when the user issues a voice command to the electronic device 1, the voice interactive system 2 will confirm the voice command by detecting the presence of a predetermined keyword.

The semantic recognition module 22 is coupled to and controlled by the detecting module 21 so as to switch operation from a disabled mode to an enabled mode, where the semantic recognition module 22 performs semantic recognition upon the voice models (M1) in a conventional manner, when the presence of the predetermined keyword in the input voice signal is detected by the detecting module 21. The semantic recognition module 22 includes a database 221 containing a plurality of voice model samples, and a voice model comparing unit 222 coupled to the detecting unit 21 and the database 221 for comparing similarity among the built voice models (M1) from the detecting unit 21 and the voice model samples in the database 221. Based on the results of the comparison performed by the voice model comparing unit 222, corresponding semantic information (such as a command for “increasing the volume”) is provided by the semantic recognition module 22 to the response module 23.

The response module 26 is coupled to and controlled by the semantic recognition module 22 so as to generate a response according to the result of the semantic recognition performed by the semantic recognition module 22. For example, the operation control module 263 of the response module 26 generates a control signal corresponding to the result of the semantic recognition (such as for “increasing the volume” as in the foregoing) and transmits the control signal to the control module 15 such that the latter activates a corresponding control circuit of the electronic device 1 to execute the desired operation.

The timer module 24 operates simultaneously with operation of the semantic recognition module 22 in the enabled mode so as to calculate an idle time between a current input voice signal and a previous input voice signal, and so as to determine whether the idle time calculated thereby is larger than a predetermined threshold.

The mode switching module 25 is coupled to the timer module 24 and the detecting module 21, and enables the detecting module 21 to switch operation of the semantic recognition module 22 from the enabled mode back to the disabled mode upon detection by the timer module 24 that the idle time between the current input voice signal and the previous input voice signal is larger than the predetermined threshold. Upon initialization of the voice interactive system 2, the voice interactive system 2 operates in the default disabled mode. Thereafter, once the detecting module 21 detects the presence of the predetermined keyword in the input voice signal (S1), the voice interactive system 2 operates in the enabled mode until the timer module 24 calculates an idle time between a current input voice signal and a previous input voice signal to be larger than the predetermined threshold, during which time operation of the voice interactive system 2 switches back to the disabled mode. From the foregoing, when the user proceeds with voice interactive operations with the electronic device 1, it only takes a single keyword input to switch the voice interactive system 2 to the enabled mode. When the voice interactive system 2 operates in the enabled mode, it is no longer necessary for the user to utter the keyword when interacting with the electronic device 1, thereby resulting in a friendlier interface between the user and the voice interactive system 2.

In this embodiment, the response module 26 further includes the image response module 261 that provides image data corresponding to the result of the semantic recognition performed by the semantic recognition module 22 to the imaging module 14, and the voice response module 262 that provides artificial voice response data corresponding to the result of the semantic recognition performed by the semantic recognition module 22 to the reproduction module 13. When a voice model sample corresponding to an input voice signal (S1) is recognized by the semantic recognition module 22, the image response module 261 and the voice response module 262 retrieve and decompress predetermined compressed files of image data and artificial voice response data that are configured for response to the voice model for subsequent output to the imaging module 14 and the reproduction module 13, respectively. For instance, when the semantic recognition module 22 recognizes the command “increase the volume” from the user, the corresponding predetermined compressed files of image data and artificial voice response data can be configured as a picture indicating, or a text (including an icon) showing “Yes, I will increase the volume for you!”, and a voice content of “Yes, I will increase the volume for you!”, respectively.

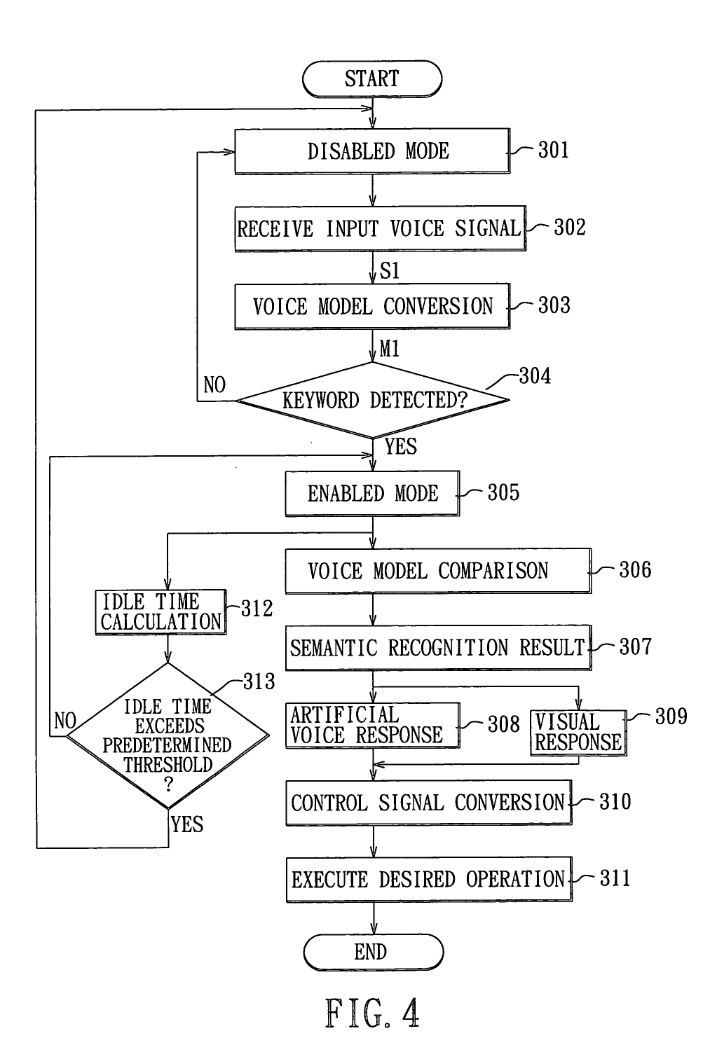

FIG. 4 is a flowchart to illustrate steps of the preferred embodiment of a voice interactive method according to the present invention.

In step 301, the voice interactive system 2 operates in the default disabled mode.

In step 302, an input voice signal is received and converted into a digital input voice signal (S1) that is provided to the detecting module 21.

In step 303, the detecting module 21 converts the digital input voice signal (S1) into a corresponding voice model (M1) that is to be provided to the semantic recognition module 22.

In step 304, the semantic recognition module 22 determines whether the voice model (M1) includes the predetermined keyword. In the negative, the flow goes back to step 301. Otherwise, the flow goes to step 305, where the voice interactive system 2 switches operation to the enabled mode.

In step 306, the semantic recognition module 22 performs voice model comparison to find a sample in the database 221 that has a largest similarity to the voice model (M1). Subsequently, a semantic recognition result is generated in step 307. Thereafter, in steps 308 and 309, an artificial voice response and a visual response corresponding to the semantic recognition result are generated through the response module 26.

Furthermore, in steps 310 and 311, the operation control module 263 of the response module 26 generates a control signal corresponding to the semantic recognition result, and transmits the control signal to the control module 15 such that the electronic device 1 is able to execute the operation desired by the user.

When the voice interactive system 2 operates in the enabled mode, as indicated in steps 312 and 313, the timer module 24 determines whether an idle time between a current input voice signal and a previous input voice signal calculated thereby is larger than the predetermined threshold. In the negative, the enabled mode is maintained. Otherwise, operation of the voice interactive system 2 is switched back to the disabled mode, i.e., the flow goes back to step 301.

The following example is provided to illustrate a typical conversation between the user and the voice interactive system 2. In the example, it is assumed that the system keyword is “Jack”, and the electronic device 1 that incorporates the voice interactive system 2 is a multi-media playback apparatus. While the following illustrative conversation between the user and the voice interactive system 2 is in the English language, the language of the conversation should not be limited thereto:

User: Jack, activate the CD player.

System: All right, I'll activate the CD player for you.

User: Play the songs of xxx.

System: All right, I'll play the songs of xxx for you.

User: Play the third song.

System: All right, I'll play the third song for you.

User: Louder.

System: All right, I'll turn up the music for you.

(After an idle time exceeding the predetermined threshold has elapsed)

User: Jack, turn off the CD player.

System: All right, turn off the CD player for you.

As evident from the above conversation, the voice interactive system 2 is convenient to use since there is no need for the user to recite the same keyword when the user issues voice commands while the voice interactive system 2 operates in the enabled mode. Accordingly, this invention provides a method and system for voice interaction that can eliminate the possibility of unwanted responses and that can provide a user-friendly environment. Moreover, by removing some components, such as the response module 26, the system of this invention can be applied for use as a selective voice recognition system.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

1. A voice interactive method comprising:
a) performing voice recognition upon an input voice signal to detect presence of a predetermined keyword;
b) upon detecting that the input voice signal contains the predetermined keyword, performing semantic recognition upon the input voice signal;
c) generating a response according to result of the semantic recognition performed in step b);
d) simultaneous with step b), calculating an idle time between a current input voice signal and a previous input voice signal; and
e) disabling the semantic recognition of the input voice signal, and repeating step a) when the idle time calculated in step d) is larger than a predetermined threshold.

2. The voice interactive method as claimed in claim 1, wherein step c) includes:
generating a signal corresponding to the result of the semantic recognition performed in step b), and transmitting the signal to an electronic device such that the electronic device operates in response to the signal received thereby.

3. The voice interactive method as claimed in claim 1, wherein step c) includes generating an artificial voice response corresponding to the result of the semantic recognition performed in step b).

4. The voice interactive method as claimed in claim 1, wherein step c) includes generating an image that corresponds to the result of the semantic recognition performed in step b).

5. A selective voice recognition method comprising:
a) performing voice recognition upon an input voice signal to detect presence of a predetermined keyword;
b) upon detecting that the input voice signal contains the predetermined keyword, performing semantic recognition upon the input voice signal;
c) simultaneous with step b), calculating an idle time between a current input voice signal and a previous input voice signal; and
d) disabling the semantic recognition of the input voice signal, and repeating step a) when the idle time calculated in step c) is larger than a predetermined threshold.

6. A voice interactive system comprising:
a detecting module adapted for performing voice recognition upon an input voice signal to detect presence of a predetermined keyword;
a semantic recognition module coupled to and controlled by said detecting module so as to switch operation from a disabled mode to an enabled mode, where said semantic recognition module performs semantic recognition upon the input voice signal, when the presence of the predetermined keyword in the input voice signal is detected by said detecting module;
a response module coupled to and controlled by said semantic recognition module so as to generate a response according to result of the semantic recognition performed by said semantic recognition module;
a timer module which operates simultaneously with operation of said semantic recognition module in the enabled mode so as to calculate an idle time between a current input voice signal and a previous input voice signal, and so as to determine whether the idle time calculated thereby is larger than a predetermined threshold; and
a mode switching module coupled to said timer module and said detecting module, said mode switching module enabling said detecting module to switch operation of said semantic recognition module from the enabled mode back to the disabled mode upon detection by said timer module that the idle time between the current input voice signal and the previous input voice signal is larger than the predetermined threshold.

7. The voice interactive system as claimed in claim 6, wherein said response module includes an operation control module for generating a signal corresponding to the result of the semantic recognition performed by said semantic recognition module, said operation control module being adapted to transmit the signal generated thereby to an electronic device such that the electronic device operates in response to the signal.

8. The voice interactive system as claimed in claim 6, wherein said response module includes a voice response module for providing artificial voice response data corresponding to the result of the semantic recognition performed by said semantic recognition module.

9. The voice interactive system as claimed in claim 6, wherein said response module includes an image response module for providing image data that corresponds to the result of the semantic recognition performed by said semantic recognition module.

10. The voice interactive system as claimed in claim 6, wherein said detecting module includes:
a feature parameter retrieving unit for retrieving feature parameters of the input voice signal;
a voice model building unit coupled to said feature parameter retrieving unit for building voice models with reference to the feature parameters retrieved by said feature parameter retrieving unit;
a keyword voice modeling unit for storage of keyword voice models; and
a voice model comparing unit coupled to said voice model building unit and said keyword voice modeling unit for comparing similarity among built voice models and the keyword voice models.

11. The voice interactive system as claimed in claim 10, wherein said semantic recognition module includes a database containing a plurality of voice model samples, and a voice model comparing unit coupled to said detecting unit and said database for comparing similarity among the built voice models and the voice model samples.

12. A selective voice recognition system comprising:
a detecting module adapted for performing voice recognition upon an input voice signal to detect presence of a predetermined keyword;
a semantic recognition module coupled to and controlled by said detecting module so as to switch operation from a disabled mode to an enabled mode, where said semantic recognition module performs semantic recognition upon the input voice signal, when the presence of the predetermined keyword in the input voice signal is detected by said detecting module;
a timer module which operates simultaneously with operation of said semantic recognition module in the enabled mode so as to calculate an idle time between a current input voice signal and a previous input voice signal, and so as to determine whether the idle time calculated thereby is larger than a predetermined threshold; and
a mode switching module coupled to said timer module and said detecting module, said mode switching module enabling said detecting module to switch operation of said semantic recognition module from the enabled mode back to the disabled mode upon detection by said timer module that the idle time between the current input voice signal and the previous input voice signal is larger than the predetermined threshold.

13. An electronic device comprising:
a sound pickup module adapted for receiving an input voice signal;
a detecting module coupled to said sound pickup module and operable so as to perform voice recognition upon the input voice signal to detect presence of a predetermined keyword;
a semantic recognition module coupled to and controlled by said detecting module so as to switch operation from a disabled mode to an enabled mode, where said semantic recognition module performs semantic recognition upon the input voice signal, when the presence of the predetermined keyword in the input voice signal is detected by said detecting module;
a response module coupled to and controlled by said semantic recognition module so as to generate a response according to result of the semantic recognition performed by said semantic recognition module;
a timer module which operates simultaneously with operation of said semantic recognition module in the enabled mode so as to calculate an idle time between a current input voice signal and a previous input voice signal, and so as to determine whether the idle time calculated thereby is larger than a predetermined threshold; and
a mode switching module coupled to said timer module and said detecting module, said mode switching module enabling said detecting module to switch operation of said semantic recognition module from the enabled mode back to the disabled mode upon detection by said timer module that the idle time between the current input voice signal and the previous input voice signal is larger than the predetermined threshold.

14. The electronic device as claimed in claim 13, wherein said response module includes an operation control module for generating a signal corresponding to the result of the semantic recognition performed by said semantic recognition module, said electronic device further comprising a control module coupled to said operation control module, said operation control module transmitting the signal generated thereby to said control module such that said control module operates in response to the signal.

15. The electronic device as claimed in claim 13, wherein said response module includes a voice response module for providing artificial voice response data corresponding to the result of the semantic recognition performed by said semantic recognition module, said electronic device further comprising a reproduction module coupled to said voice response module for audibly reproducing the artificial voice response data.

16. The electronic device as claimed in claim 13, wherein said response module includes an image response module for providing image data that corresponds to the result of the semantic recognition performed by said semantic recognition module, said electronic device further comprising an imaging module coupled to said image response module for providing a visual indication of the image data.
